(19) United States
(12) Patent Application Publication
(10) Pub. No.: US 2020/0139624 A1
(43) Pub. Date: May 7, 2020

(54) ADDITIVE MANUFACTURING EXTRUDER

(71) Applicant: THE GOVERNORS OF THE UNIVERSITY OF ALBERTA, Edmonton (CA)

(72) Inventors: Mohammad Abu Hasan Khondoker, Edmonton (CA); Dan Sameoto, Edmonton (CA)

(21) Appl. No.: 16/178,281

(22) Filed: Nov. 1, 2018

(51) Int. Cl. B29C 64/209; B33Y 10/00; B33Y 30/00; B29C 64/118; B22F 3/00

(52) U.S. Cl. CPC B29C 64/209; B33Y 10/00; B22F 3/008; B29C 64/118; B33Y 30/00

(57) ABSTRACT

An additive manufacturing extruder includes a melt chamber with a heat source, having a first inlet for receiving a first extrudable material and a second inlet for receiving a second extrudable material, and an interior channel leading to an outlet leading to a nozzle; and a intermixer associated with the outlet or the nozzle. The intermixer directs flow of the extrudable materials to produce a mechanically keyed extrudate.

The present invention generally relates to an additive manufacturing extruder comprising an intermixer.

### BACKGROUND

Additive manufacturing (AM) is a group of techniques that use three-dimensional computer-aided-designs (CAD) to fabricate a three-dimensional object by selectively adding materials, usually layer by layer, as opposed to traditional subtractive manufacturing techniques like CNC machining where the desired object is fabricated by selectively removing the material. The benefits of AM technologies include, but are not limited to, higher fabrication speed, minimal material wastage, higher complexity of fabricated objects, and reduced numbers of processing stages.

Although ASTM International defines three-dimensional (3D) printing as a group of technologies where the build material is selectively deposited using a print head or nozzle realizing the overall 3D object, the term “3D printing” is sometimes synonymously used with AM techniques. Among these AM techniques, fused deposition modeling style 3D printing is an extrusion based technique which involves low cost, efficient deposition of material and minimal wastage.

Fused deposition modeling (FDM) is a rapid prototyping (RP) technology that deposits molten polymer through a nozzle to develop two-dimensional (2D) cross-sectional layers, which are layered to form the three-dimensional (3D) object in an additive manner. The biggest advantage of this technique is its ability to print any arbitrary complex geometry without costly tooling or significant post-processing. However, FDM printing has been limited in materials properties within a single part. At present, functionally graded material (FGM) parts made of multiple dissimilar materials cannot be printed by commercial multi-material FDM systems since they use separate nozzles for each material, and thus are unable to deposit multiple materials in same extrudate.

In FDM, a filament, typically a thermoplastic material, is fed from a material spool to the print head by a motor-gear feeder assembly. The print head consists of a melt-chamber, a heater block, a temperature sensor, and a nozzle. The heater block and temperature sensor are synchronized with a temperature controller to maintain the desired temperature of the melt-chamber. The fed filament is melted in the melt-chamber and then extruded through the nozzle orifice. Although in most FDM systems the print head moves along horizontal X and Y-axes, the mechanism of Z-movement may vary. Some systems have the print head movable along the Z-axis as well, while in other systems the Z-movement is achieved by moving the print bed itself. The molten material is deposited as successive 2D layers, where each new layer is added on top of the prior one, finally constructing the 3D object. FIG. 1 shows the schematic diagram of a typical FDM system.

There are some major limitations of FDM parts, such as inherent poor surface finish with ridges, low inter-layer bond strength, and limited printing resolution. In FDM parts, both intra-layer and inter-layer bonding are important in determining the overall mechanical strength of the printed object. Since in FDM systems each new layer is deposited onto the previous layer, the inter-layer adhesion strength increases when the temperature of the prior layer is higher while printing a new layer, which ensures enough diffusion of the polymeric chains. Low inter-layer bond strength is one of the major factors weakening FDM parts compared to the material's bulk strength. That leads to issues like delamination when multiple immiscible materials are printed with just side-by-side co-extrusion in a single FDM part. Hence, the multi-material FDM systems need special attention to make sure the printed objects have enough mechanical stability when printing using immiscible polymers.

One limitation of multi-material FDM systems using separate nozzles for each material is they are unable to print functionally graded materials (FGM) with a gradual blended transition from one material to another. This gradient may be very important for functional devices as well as to reduce internal stress gradients and delamination. Multi-material objects printed with FDM printers having separate nozzles usually have a sharp transition from one material to another, resulting in poor bonding in these locations.

Immiscible polymer pairs are likely to have bonding failures at their interface. There are a number of reported compatibilization methods to enhance bonding at the interface of two immiscible polymers, however, these techniques are designed for flat sheets of polymers and not suitable with FDM systems without additional processing steps. As an alternate solution to this issue, mechanical approaches to resist separation of the polymers at their interface can be applied.

Direct mechanical interlocking is an adhesion mechanism preventing separation of two polymeric surfaces. Therefore, it is desired to extrude immiscible polymers with a degree of intermixing to achieve mechanical keying while printing a single FGM device. However, generally the bonds between layers are not strong compared to that of other AM techniques.

Most FDM systems use non-flexible, non-stretchable materials like ABS, PLA, HIPS, nylon and other hard thermoplastics. A few FDM systems can also print objects using specially modified semi-flexible but non-stretchable materials like NinjaFlex®. There has been very limited reported work where soft elastomers are employed in FDM systems, however there are reports of a commercial printer with a modified feeder system which can accommodate soft thermoplastics with hardness of 72 and 78 Shore A. Currently, there are no available printers that use very soft thermoplastic elastomers like styrene ethylene butylene styrene (SEBS) based Kraton G1657 with hardness of only 47 Shore A. The capability to print very soft stretchable materials like SEBS is highly desirable for fabricating tunable electronic devices.

There are commercially available FDM systems which can print multiple materials with separate nozzle systems. For instance, RoVa3D commercialized by ORD Solutions uses 5 separate nozzles for 5 different filaments. However, printing of FGM requires use of a single nozzle for multiple materials. The FGM defines a special class of engineering materials exhibiting spatially inhomogeneous content, tailoring the devices made of this material to specific functional and performance requirements.

Other AM techniques have been used to print FGM devices. For example, multi-material compliant joints have been printed using polyjet technology. There are a few open source FDM systems from the hobbyist community, which use a single nozzle for two or three materials with limited reported flexibility in material choices as inputs. These have primarily been used for blending colors of the same material, for example PLA. Some of these FDM systems print only one material at a time, and others print multi-material objects by simple side-by-side co-extrusion.

Therefore, there remains a need in the art for an additive manufacturing printer which can produce objects from two or more dissimilar materials, which are mechanically keyed together.

### SUMMARY OF THE INVENTION

In one aspect, the invention comprises an additive manufacturing extruder and intermixer, which is configured to produce mechanical keying of the extrudate, as opposed to side-by-side co-extrusion. In one embodiment, the extruder may print at least two dissimilar thermoplastic materials with side-by-side co-extrusion or mechanically interlocked extrusion. This intermixing feature may also enhance the inter-layer bond strength of the printed objects by ensuring at least some areas of the bonding interface are between the same material.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 shows components of a typical FDM extruder;

FIG. 2 is an exploded view of the 3D model of a bi-extruder according to an embodiment of the present disclosure;

FIG. 3 is an assembly photograph of the bi-extruder of FIG. 2 manufactured;

FIG. 4 shows an internal liquefier divided into five different zones;

FIG. 5 is a graph showing shear viscosity data with Cross-WLF fitted curve for ABS resin sourced from The Dow Chemical Company (CCarl Hanser Verlag GmbH & Co.KG, Muenchen);

FIG. 6 shows the temperature distribution of the bi-extruder in thermal analysis using ANSYS Workbench;

FIG. 7 is a photograph showing the front view of the assembled bi-extruder print head;

FIG. 8A shows a passive helical intermixer;

FIG. 8B shows an alternative embodiment of a passive intermixer with inclined baffles;

FIG. 8C shows an image showing an intermixer inserted into the bi-extruder channel;

FIG. 9 shows a deformable intermixer enabling both intermixed and side-by-side extrusion;

FIG. 10A shows a long nozzle with intermixer (all dimensions are in mm);

FIG. 10B shows a short nozzle (all dimensions are in mm);

FIG. 11 is an exploded view of a tri-extruder according to an embodiment of the present disclosure;

FIG. 12 shows a split tri-extruder according to an embodiment of the present disclosure manufactured;

FIG. 13 shows the working principle of the deformable intermixer enabling both intermixed and side-by-side co-extrusion;

FIG. 14A shows the step response test of the bi-extruder with intermixer inserted;

FIG. 14B shows the step response test of the bi-extruder without an intermixer;

FIG. 15 shows a graphical representation of the extrudate diameter from different nozzles;

FIG. 16 shows a graphical representation of the die swelling of HIPS when extruded with a 1-mm nozzle;

FIG. 17A shows a microscope image of a cross-section of extrudate with a desired composition with the ratio of Red:Green=1:0. The estimated composition is also given. The scale bar is 0.25 mm long;

FIG. 17B shows a microscope image of a cross-section of extrudate with a desired composition with the ratio of Red:Green=3:1. The estimated composition is also given. The scale bar is 0.25 mm long;

FIG. 17C shows a microscope image of a cross-section of extrudate with a desired composition with the ratio of Red:Green=1:1. The estimated composition is also given. The scale bar is 0.25 mm long;

FIG. 17D shows a microscope image of a cross-section of extrudate with a desired composition with the ratio of Red:Green=1:3. The estimated composition is also given. The scale bar is 0.25 mm long;

FIG. 17E shows a microscope image of a cross-section of extrudate with a desired composition with the ratio of Red:Green=0:1. The estimated composition is also given. The scale bar is 0.25 mm long;

FIG. 18A shows a microscope image of a cross-section of mechanically interlocked extrudate of green and red PLA, extruded from a 1 mm nozzle. Scale bar is 0.25 mm long;

FIG. 18B shows a microscope image of a cross-section of mechanically interlocked extrudate of green and red PLA, extruded from a 1 mm nozzle. Scale bar is 0.25 mm long;

FIG. 18C shows a microscope image of a cross-section of mechanically interlocked extrudate of green and red PLA, extruded from a 1 mm nozzle. Scale bar is 0.25 mm long;

FIG. 18D shows a microscope image of a cross-section of mechanically interlocked extrudate of green and red PLA, extruded from a 0.5 mm nozzle. Scale bar is 0.25 mm long;

FIG. 18E shows a microscope image of a cross-section of mechanically interlocked extrudate of green and red PLA, extruded from a 0.5 mm nozzle. Scale bar is 0.25 mm long;

FIG. 18F shows a microscope image of a cross-section of mechanically interlocked extrudate of green and red PLA, extruded from a 0.5 mm nozzle. Scale bar is 0.25 mm long;

FIG. 18G shows a microscope image of a cross-section of mechanically interlocked extrudate of green and red PLA, extruded from a 0.35 mm nozzle. Scale bar is 0.25 mm long;

FIG. 18H shows a microscope image of a cross-section of mechanically interlocked extrudate of green and red PLA, extruded from a 0.35 mm nozzle. Scale bar is 0.25 mm long;

FIG. 18I shows a microscope image of a cross-section of mechanically interlocked extrudate of green and red PLA, extruded from a 0.35 mm nozzle. Scale bar is 0.25 mm long;

FIG. 19 is a graph showing the failure strengths of 100% HIPS extrudate with a diameter of 1.02±0.02 mm, 1:1 HIPS-ABS extrudate (side-by-side) with a diameter of 1.03±0.04 mm, 1:1 HIPS-ABS extrudate (intermixed) with a diameter of 1.04±0.03 mm and 100% ABS extrudates from the tensile tests;

FIG. 20A shows the comparison between the failure bond strengths of side-by-side and intermixed samples;

FIG. 20B shows the printed surfaces from side-by-side and intermixed co-extrusion. The scale bars are 0.3 mm long;

FIG. 21A shows the Geeetech 3D printer with custom tri-extruder head installed on it;

FIG. 21B shows the assembly of the tri-extruder head;

FIG. 22A shows the dimensions of the 2D planar samples;

FIG. 22B shows the orientation of rectangular sheets printed;

FIG. 22C shows the top view of model surfaces printed for X-samples;

FIG. 22D shows Y-samples with their theoretical cross-sections across the printed infills;

FIG. 23A shows the photos of 2D planar samples, Y-sample (left), X-sample (middle) and intermixed sample (right). All the samples have the same 1:1 red HIPS and blue ABS;

FIG. 23B shows the microscope image of the top surface of a Y-sample. The sample has a 1:1 red HIPS and blue ABS;

FIG. 23C shows the microscope image of the top surface of a X-sample. The sample has a 1:1 red HIPS and blue ABS;

FIG. 23D shows the microscope image of the top surface of an intermixed sample cut by CO2 laser cutter. The sample has a 1:1 red HIPS and blue ABS;

FIG. 24A shows the effect of nozzle temperature on the adhesion strength of adjacent fibers in 2D planar samples;

FIG. 24B shows the effect of layer width on the adhesion strength of adjacent fibers in 2D planar samples;

FIG. 24C shows the effect of print speed on the adhesion strength of adjacent fibers in 2D planar samples;

FIG. 24D shows photos of an intermixed 2D sample (left) and a side-by-side 2D sample (right). The microscope images of the failed cross-sections of these planar samples: side-by-side X sample (inset-top) and intermixed sample (inset bottom);

FIG. 24E shows ultimate tensile strength (UTS) of 3D samples (both intermixed and side-by-side) with different composition of HIPS and ABS; and

FIGS. 24F-24G show the microscopic images of two representative side-by-side (FIG. 24F) and intermixed (FIG. 24G) samples having the same 50%-50% composition of red HIPS and blue ABS (scale bars are 2 mm).

### DETAILED DESCRIPTION

Embodiments of the present invention comprise an extruder and intermixer that can result in mechanical keying of the extrudate. The present disclosure provides an extruder having the capability of printing two or more dissimilar materials with either side-by-side co-extrusion or mechanically keyed extrusion. This intermixing feature can also enhance the inter-layer bond strength of the printed objects by ensuring at least some areas of the bonding interface are between the same material.

As used herein “mechanical keying” means a method of combining two or more dissimilar materials by introducing physical entanglement along their non-linear and/or non-planar interface. Side-by-side co-deposition does not result in mechanical keying because it corresponds to placing two materials in contact along their linear or planar interface. Mechanical keying and side-by-side co-deposition do not refer to adhesion at a microscopic or molecular level, some level of which will occur at any interface between two dissimilar materials.

As used herein, “dissimilar materials” refers to any two materials which have at least one dissimilar property, and may include materials which are immiscible with each other.

Mechanically keyed extrudates comprising two or more dissimilar materials allows intermixing of immiscible polymers into a more cohesive end product. Intermixing of two polymers immediately next to the nozzle orifice can in theory greatly enhance bond strength of the polymer interface within and between filaments.

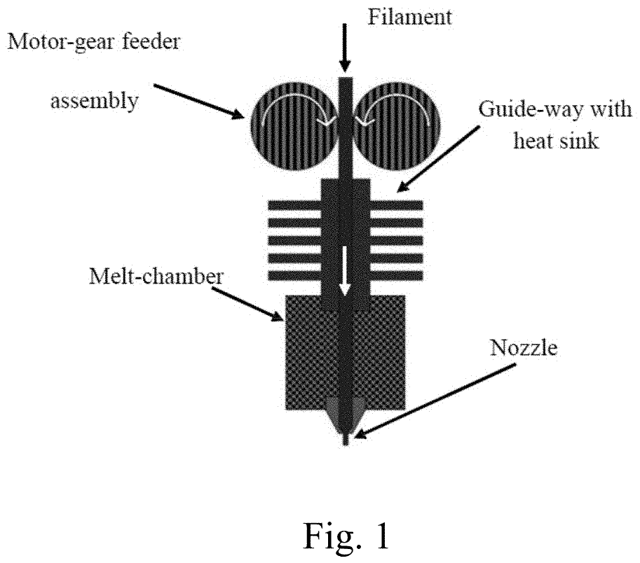

A conventional FDM extruder, as shown in FIG. 1, comprises a motor-gear feeder assembly (1), a guide-way (2), a melt-chamber (3) and a nozzle (4). The motor-gear assembly will typically include a stepper motor (not shown), a drive gear (not shown), and an idler (5). The idler may be grooved or toothed to enhance the friction between the idler and the filament. The drive gear is coupled with the motor shaft and the filament is placed between the idler and the drive gear. Hence, when the motor shaft rotates the filament is fed towards the melt-chamber in a controlled manner. Above the idler-gear contact, the filament is in tension because it's being pulled from the material spool to the feeder assembly, and below the idler-gear contact, the filament is in compression because it is being pushed from the feeder assembly to the melt-chamber. Ideally, a no-slip boundary condition is assumed between the filament surface and the idler/gear tooth. Slip may occur due to non-optimal design of idler/gear tooth, insufficient torque applied by the motor, or a higher pressure in the melt-chamber due to an inadequate rate of polymer melting.

In general terms, a multi-extruder of the present invention may comprise:
(a) a melt chamber comprising a heat source, and having a first inlet for receiving a first extrudable material and a second inlet for receiving a second extrudable material, and an outlet leading to a nozzle; and
(b) an intermixer associated with the outlet or the nozzle, the intermixer configured to direct the flow of one or both of the two extrudable materials to produce a mechanically keyed extrudate.
   At least two guideways (20, 22) are attached to the inlets (32, 34) and may comprise a cooling or heat dissipation element. As shown, a heat sink (24) comprises a plurality of heat dissipating fins or disks.

An intermixer will be placed in the axial flowpath of the at least two extrudable materials, and comprise at least one blade disposed on a shaft which diverts axial fluid flow in a non-axial direction. Preferably, a plurality of blades divert the flow of each extrudable material so as to intermix with each other.

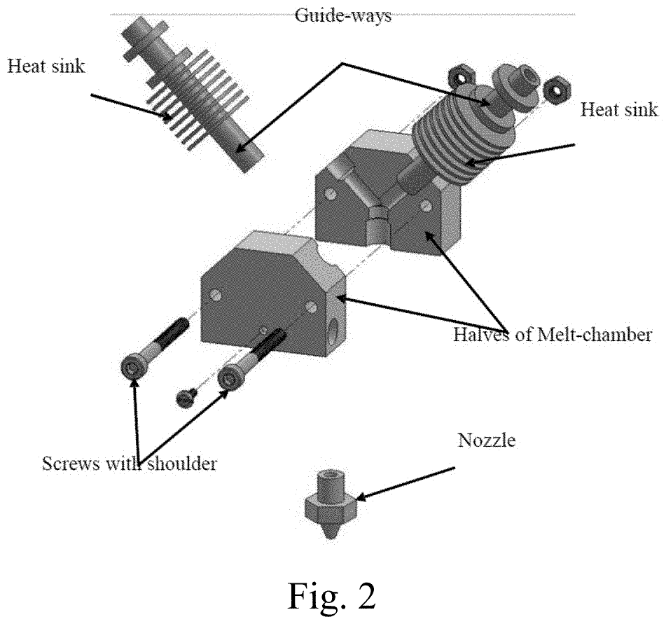

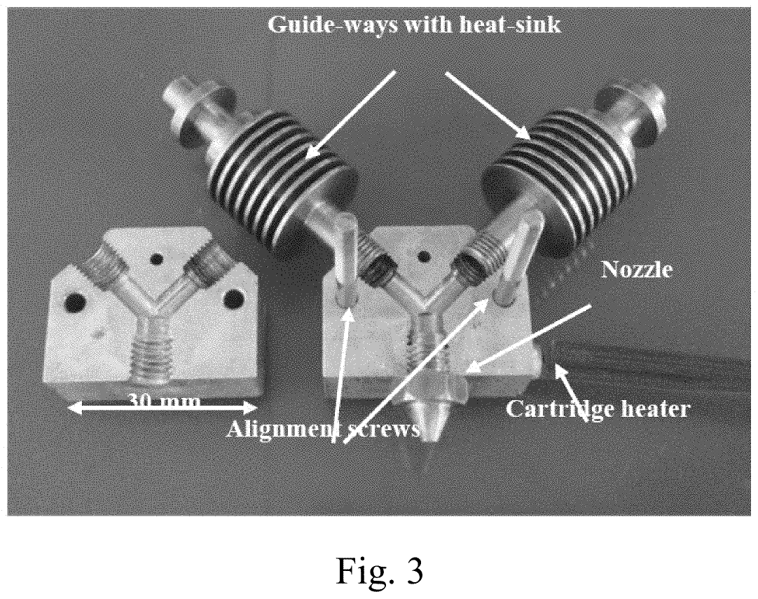

In some embodiments, the nozzle (40) is directly attached to the melt chamber (30), as illustrated in FIG. 2 and FIG. 3. In alternative embodiments, a flexible heated tube may be provided to interconnect the melt chamber (or melt chambers) to a print head comprising a nozzle. In these embodiments, the melt chamber(s) may be held stationary while the print head translates in 2 or 3 dimensions during printing. The intermixer may be disposed within the nozzle, or in some intermediate location between the melt chamber and the nozzle.

The intermixer can also function as mechanical valve to control immediate ON/OFF of the melt deposition through the nozzle. The intermixer could comprise a valve element (42) which may be physically displaced towards the nozzle so as to block the nozzle orifice for a period of time when extruder is performing non-printing movement.

The filament may comprise any meltable and extrudable filament, such as a metal or a polymer filament, numerous examples of which are commercially available in a wide array of diameters. The fed filament travels towards the melt-chamber through the guide-way, which comprises a heat-sink. The heat-sink may comprise a plurality of heat dissipating fins and ensures that the solid filament does not experience a temperature above the glass-transition temperature (T_{g}) before entering the melt-chamber. Acting as an effective piston, the solid filament inside the guide-way pushes the polymer melt towards the nozzle. It is desirable that the temperature drop across the heat-sink is large enough so that filament remains solid before entering the melt-chamber. Cooling fans or active temperature control (circulation of a coolant) may assist or ensure that result.

The filament is melted in the melt-chamber, which houses a cartridge heater and a temperature sensor, for example a thermistor. The cartridge heater supplies the heat required to melt the solid filament into a polymer melt. This heater and thermistor are coupled and programmed with a temperature controller, preferably a proportional-integral-derivative (PID) controller to maintain a constant desired temperature, all of which are well known in the art.

Finally, the molten materials are extruded through the nozzle, which may have an orifice diameter ranging from about 0.2 to about 0.5 mm. Once the extruded polymer emerges from the nozzle, it experiences a sudden change in the surrounding temperature from the melt temperature (>200° C.) to the ambient temperature (˜20° C.), causing a significant change in shear stress. These abrupt changes cause the extrudates to have slightly thicker radial dimension than the nozzle orifice when freely extruded. Additionally, due to the viscoelastic properties of the polymer melt, the extruded material tends to return to its original cross-section. Therefore, the extrudates have a larger diameter than the nozzle opening. This phenomenon is known as die swell and is very common in extrusion processes. Moreover, while printing, heat is transferred from the newly deposited layer to the prior layers resulting a vertical thermal gradient, which may lead to warping and distortion of the printed structure.

FIG. 2 shows an exploded view of an embodiment of a bi-extruder, showing the two guide-ways (20, 22) for introducing two thermoplastic filaments into the melt-chamber (30) shown split into two halves, and the nozzle (40). Preferably, the design of the heat-sink (24) of the guide-ways is configured to maximize the temperature drop. Without being limited to specific dimensions and materials, to enable heat loss from the heat-sink in the shown embodiments, the guide-ways are made of 316-stainless steel with thermal conductivity of only 12˜45 W/m-K. The split melt-chamber is made of aluminum (221˜247 W/m-K) to ensure a uniform melting temperature throughout the melt-chamber. The split configuration of this bi-extruder allows easy access to its interior channel, so that insertion of an intermixer to manipulate the flow is possible and direct comparisons to co-extrusion can be made. To make the nozzle thermally conductive and ensure scratch-free, safe operation of the tiny tip, Brass C36000 (˜116 W/m-K) is used as the nozzle material. However, one having ordinary skill in the art will readily recognize that other suitable materials may be substituted for any of these components.

The extruder melt chamber may be fashioned from a single block of material, or from two mirror-image halves split along a vertical plane, as is shown in FIG. 2, or two non-a horizontal plane separating a top and bottom portion (not shown). If assembled from multiple pieces, a high temperature gasket may be provided to prevent polymer leakage between the pieces. For example, at least one silicone gasket ring may be used.

In the assembly shown in FIG. 3, two guide-ways are threaded into the melt-chamber. The guideways may be lined or coated with a friction reducing material, such as a Teflon™ tube. During assembly, both halves of the melt-chamber are precisely aligned with partially threaded screws or pins, and the nozzle is threaded from the bottom side of the melt-chamber. Dimensions are not an essential element of the invention, however in one embodiment, the inner diameters of the guide-ways and two upper sections of the Y-shaped interior channel are both 3.1 mm, which is slightly larger than the filament diameter (3 mm) to reduce unnecessary mechanical friction between solid filaments and the metal walls. The diameter of the lower section of the Y-channel is 4 mm to allow for the insertion of a static intermixer with an outer diameter of 4 mm. The configuration and dimensions of the device can readily be modified to accommodate various design requirements.

In one embodiment, the extruder uses two 24V-40 W cartridge heaters embedded into the melt-chamber and one 100 kΩ NTC thermistor. Different brass nozzles with 1 mm, 0.5 mm and 0.35 mm tip diameters and 3-mm inner diameter at the other end may be used.

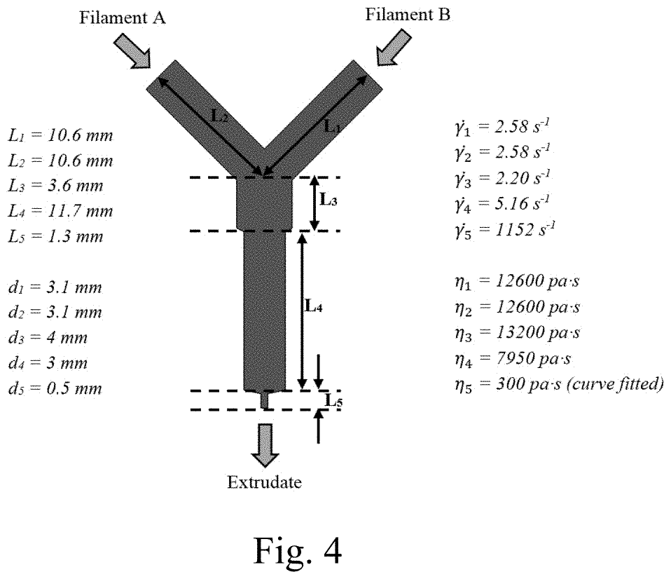

The liquefier geometry has significant impact on the polymer melt behavior in the melt-chamber. As shown in FIG. 4, the internal liquefier of the bi-extruder can be divided into five major zones: two inlet sections in the melt-chamber, the intermediate section between where both flows meet and the nozzle, the internal channel in the nozzle, and the smallest section at the nozzle tip having the exit diameter. Any gap between filament diameter and internal diameter of the channel would lead to thermal resistance to heat transfer through the channel walls. This effect is eliminated as the material melts and advances towards the nozzle. The lengths of these sections and corresponding diameters according to some specific embodiments are also given in the FIG. 4 assuming that 0.5 mm nozzle is being used.

The viscosity (η) of a viscoelastic polymer melt is both temperature and shear rate dependent. Hence, it is usually expressed as product of a temperature dependent and a shear-rate dependent terms. The shear-rate dependent term is commonly assumed to follow a power-law model with fluidity ϕ and flow exponent m, whereas the Arrhenius model is used for temperature dependent term. The power-law fit parameters are evaluated at some reference temperature, T₀. Hence, the viscosity is defined as:

$$η = {e}^{[ α ( \frac{1}{T} - \frac{1}{{T}_{0}} ) ]} \cdot {K ( \dot{γ} )}^{n - 1} \qquad Equation 1$$

Where α is activation energy, \dot{γ} is shear-rate, T is absolute temperature of the polymer melt, K is consistency index

$$( {φ}^{- \frac{1}{m}} )$$

and n is power-law index

$$( \frac{1}{m} ) .$$

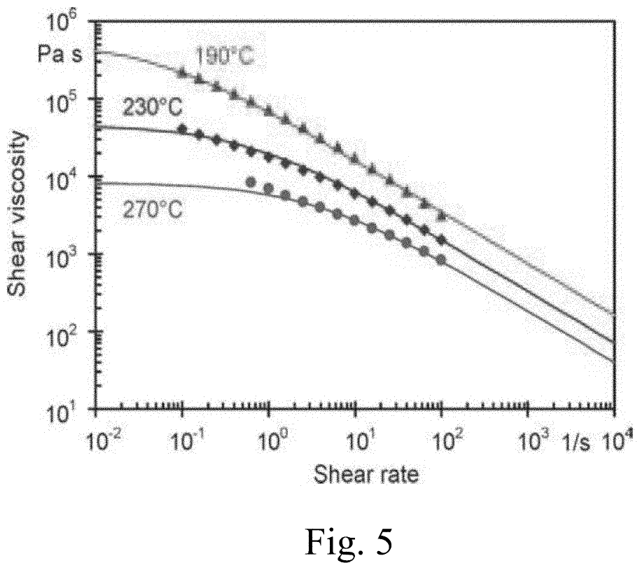

Due to the mathematical complexity, the temperature throughout the liquefier of the small scale FDM extruders is often assumed to be uniform. This assumption is supported by the thermal simulation below. Hence, it is much simpler to directly use shear viscosity data (given by the suppliers or measured by the users) over a range of shear rates in analysis of melt rheology of 3D printing materials. Due to the unavailability of the viscosity data from the supplier of the filaments used in this work, shear viscosity data with Cross-WLF model fitted curves for ABS has been adopted from literature with the expectation that the viscosity data for ABS used in this work would also be in the similar range. The apparent shear-rate (\dot{γ}ₐₚₚ) at the channel wall in each flow section of FIG. 4 must be determined using the following equation (2):

$$\dot{{γ}_{app}} = \frac{4 Q}{{π ( d / 2 )}^{3}} \qquad Equation 2$$

where Q is volumetric flow rate of the material in each section with diameter d. Once the apparent shear rate is calculated, the apparent viscosity in each section is determined from FIG. 5 at a certain temperature. In this case, viscosities of ABS melt at 230° C. temperature in each section of the bi-extruder are estimated and given in FIG. 4.

In extrusion, there are three consecutive rates involved: feed rate, melting rate, and extruding rate. If any or both of feed rate and melting rate are dominated by the extruding rate, the extrusion is said to be in starved situation resulting defects related to under-extrusion. On the other hand, if feed rate dominates excessively then it is overridden extrusion. To avoid overridden extrusion, the maximum allowable feed speed of an extruder head should be determined which primarily depends on the wattage of the heater element and the available liquefier surface through which the heat is transferred to the materials. A simplified model has been proposed in the literature, which can be extended for a more accurate estimation of heat flux (q).

Heat flux,q=\dot{m}[cₚ_{₁}(T_{g}−Tᵣ)+Cₚ_{₂}(Tₘ−T_{g})+Lₘ+cₚ_{₃}(Tₚ−Tₘ)] Equation 3

And liquefier surface, S=2πr(D)L Equation 4

where \dot{m} is the combined mass flow rate at both inlets (2ρvA), ρ is the polymer density, v is the total feed speed of both inlets, A is the cross-sectional area of the filaments, Tᵣ is room temperature, T_{g} is the glass transition temperature of the polymer, Tₘ is the melting temperature of the polymer, Tₚ is the print temperature, Lₘ is the latent heat of melting, the dimensions of the liquefier channels are diameter, D and length, L, and cₚ_{₁}, cₚ_{₂}, and cₚ_{₃} are the heat capacities of the polymer under glass transition, above glass transition, and after melting temperature, respectively.

The total pressure drop in the melt-chamber is sum of the pressure drops in section 1 or 2 and in the other three sections of FIG. 4. The pressure drops in each section (ΔP₁ to ΔP₅) can be estimated from a momentum balance on the liquefier. Key assumptions of this model include that the steady state laminar flow of incompressible polymer melt is fully developed and a no-slip boundary condition applies at the channel walls. Hence, the total pressure is, as follows:

$$Δ {P}_{Total} = 2 {( \frac{v}{φ} )}^{( \frac{1}{m} )} [ {L}_{1} {\{ \frac{m + 3}{{( \frac{{d}_{1}}{2} )}^{m + 1}} \}}^{( \frac{1}{m} )} + {L}_{3} {\{ \frac{m + 3}{{( \frac{{d}_{3}}{2} )}^{m + 1}} \}}^{( \frac{1}{m} )} + {L}_{4} {\{ \frac{m + 3}{{( \frac{{d}_{4}}{2} )}^{m + 1}} \}}^{( \frac{1}{m} )} + {L}_{5} {\{ \frac{{( \frac{{d}_{4}}{2} )}^{2} ( m + 3 )}{{( \frac{{d}_{5}}{2} )}^{m + 3}} \}}^{( \frac{1}{m} )} ] {e}^{[ α ( \frac{1}{T} - \frac{1}{{T}_{α}} ) ]} \qquad Equation 5$$

In one embodiment, cooling fans are used at the heat-sink of two guide-ways to induce forced convection. With two fans each with a rating of 7 cfm, the convective film co-efficient (h) of 24.92 W/m²-° C. is estimated for this case using the following Hilpert correlation:

Nu=0.683 Re^{0.466}Pr^{1/3} Equation 6

where, Nu, Re, and Pr are the Nusselt number, Reynolds number and Prandtl number, respectively, of the air flow through the heat-sink.

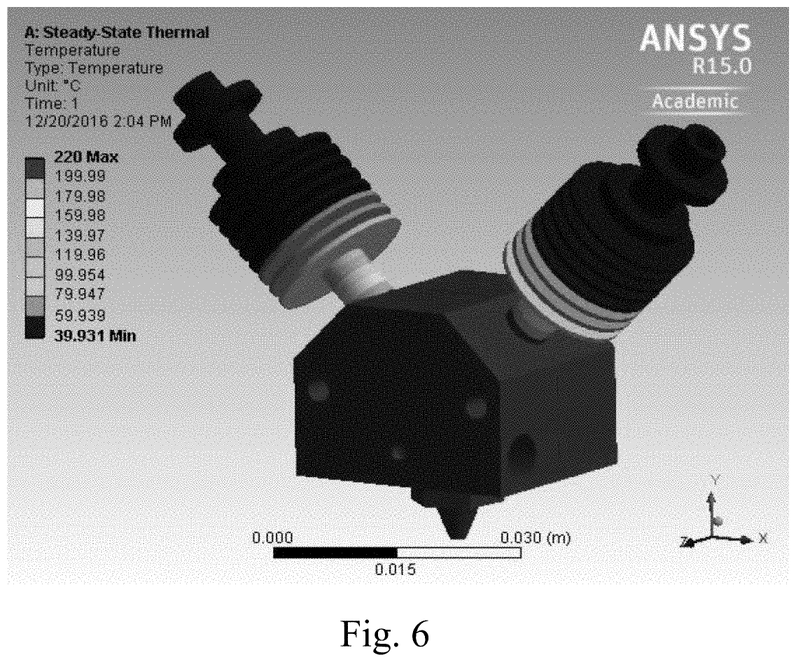

FIG. 6 shows the temperature distribution throughout the bi-extruder from the thermal simulation performed in ANSYS Workbench. In this simulation, the heater block is set at 220° C. and forced convection with an estimated convective co-efficient (h) is assumed at the heat-sink. On the other surfaces of the extruder, a free convection with 25° C. room temperature is assumed. From the analysis, the temperatures of the upper ends of the guide-ways are found to be less than 40° C.

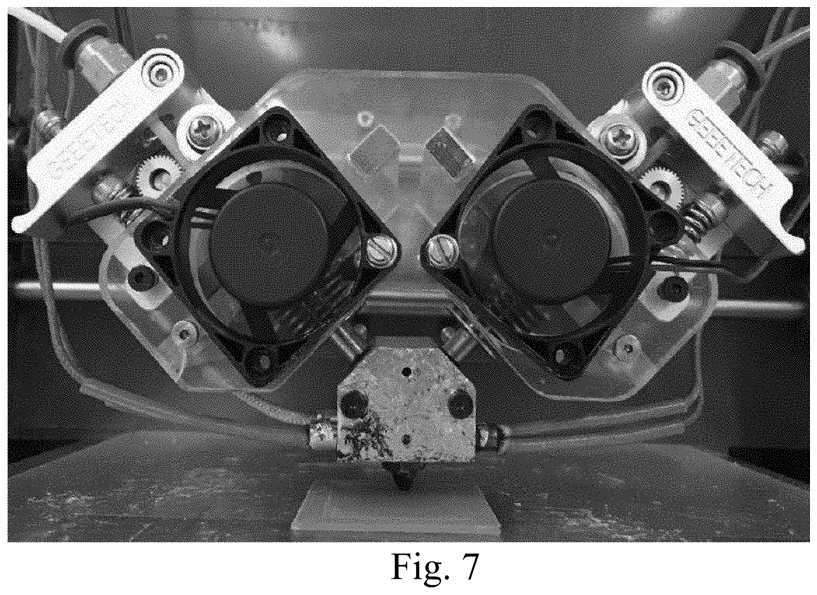

FIG. 7 shows one embodiment of a bi-extruder of the present invention. A housing (50) firmly holds the bi-extruder, the direct-mount feeding motors (52), the guideways, and the cooling fans (54). These components, along with the housing, comprise the extruder head (100). Then this extruder head (100) is installed on a commercially available, simple and inexpensive FDM style 3D printer (Model: M201) purchased from Geeetech, China as Do-It-Yourself (DIY) kit.

This 3D printer is driven by a GTM32 control system, which is based on the STM32 processor and paired with an ARM Cortex-M3. The driver comes with firmware which can run the two feeder motors at different speeds to achieve any desired composition of the fed filaments. Two bipolar stepper motors having 26 N-m holding torques with 1.8° step angles, and two DC brushless cooling fans (24 V, 0.1 A) are used in this system.

### Intermixer

To achieve mechanical keying of two polymers in an FDM system, the present invention uses an intermixer, which may be an active intermixer or a passive intermixer. Active intermixers use power from an external source and generally mixes multiple flows by active motion of the intermixer. In passive mixing, the intermixer is kept static and flow passes through the intermixer, where mixing is achieved by chaotic advection of the flow itself. Mixing comes at the expense of extra resistance to flow with longer static intermixers providing better blending but more losses from friction. True and complete blending of the polymers is not required here to overcome the delamination issues, rather some extent of mechanical keying would be enough. Therefore, passive intermixers are preferred as they provide sufficient intermixing to achieve mechanical keying, and avoid the need of an additional power source.

The intermixer will have a longitudinal axis substantially parallel to material flow past the intermixer and comprise at least one blade which is inclined to the longitudinal axis. As a result, the at least one blade will direct the flow of at least one material flow so as to intermix with an adjacent material flow. Preferably, the blade directs the flow of both materials at cross-angles. The intermixer may comprise a plurality of helical or inclined blades.

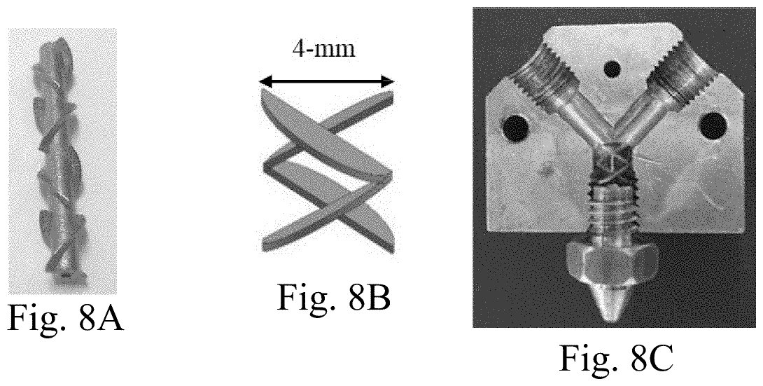

In one embodiment, as shown in FIG. 8A, the intermixer comprises a helical passive intermixer comprising two right-hand and two left-hand helical blades, which are alternated and axially spaced. The start-edges of the baffles are angularly disposed with respect to each other. If the intermixer is inserted in to the nozzle, the edges of the baffles extend across the bore of the nozzle. Due to the viscoelastic properties of the polymer melt, mixing by chaotic advection would result in higher internal pressure in the mixing zone. Therefore, in one embodiment, the helical intermixer was modified by adding a central hollow tube of 2 mm OD and 0.8 mm ID to strengthen the overall intermixer. As described below, this central hollow tube may be used to deliver another material through the melt chamber. Preferably, the intermixer self-centres within the nozzle.

In another embodiment, the intermixer may comprise a passive intermixer comprises inclined blades, each of which is a semi-ellipse. The blades may be inclined in the pattern shown in FIG. 8B. The individual blades have an elliptical shape to ensure that the inclined blades fit in the circular channel when inclined at an angle, which may be 30° from the horizontal, for example.

The intermixer blades may be mounted on a central tube, which is aligned longitudinally within the interior chamber and/or the nozzle. The central tube may carry another extrudable material, as described within.

Regardless of its shape, the intermixer may preferably be formed from a temperature refractive material, such as stainless steel, so that it can withstand a higher temperature (>200° C.) inside the melt-chamber without noticeable changes in mechanical properties.

In one embodiment, the intermixer may be installed in the outlet of the melt chamber, immediately above the nozzle, as is shown in FIG. 8C.

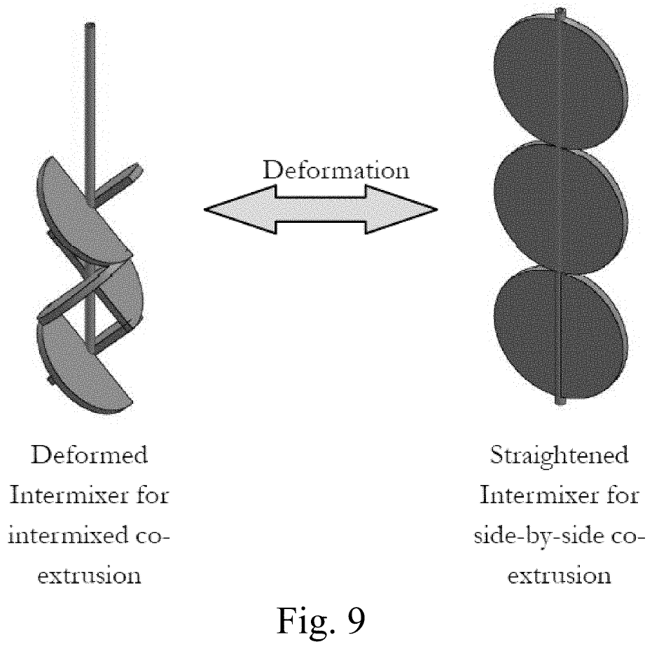

In one embodiment, the intermixer may be convertible to facilitate both side-by-side co-extrusion and mechanically keyed extrusion. As shown in FIG. 9, the intermixer may be deformable to assume two different shapes. A first shape (FIG. 9 left) forces intermixing of the two melted streams. A second shape (FIG. 9, right), which can be formed by straightening the deformed shape, substantially eliminates intermixing, and results in side-by-side co-extrusion.

### Nozzles

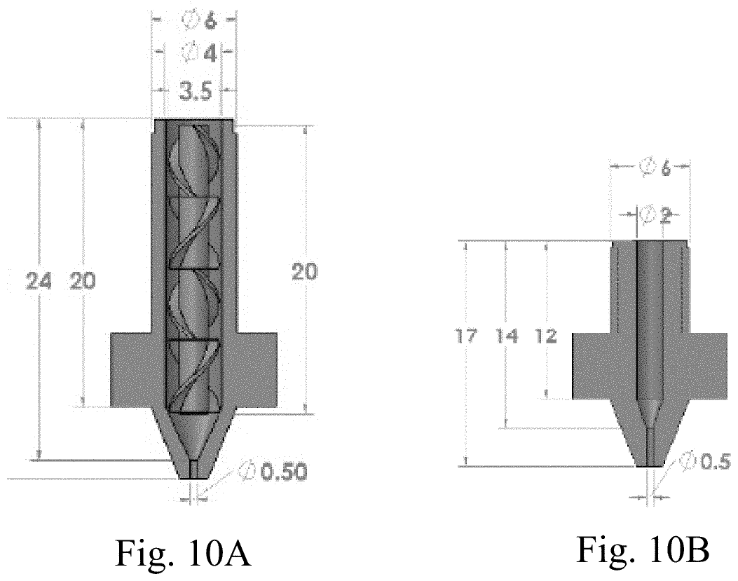

In one embodiment, two different nozzles may be provided and used. A long nozzle may facilitate the use of an intermixer which is inserted in the nozzle, as is shown in FIG. 10A, while a short nozzle (FIG. 10B) may be used for simple side-by-side co-extrusion. While dimensions are not an essential element, a long nozzle may have an overall height of about 25 mm, a 4 mm ID at one end which is straight down to 20 mm depth, then tapered to the tip diameter that has a bore length of 1 mm. On the other hand, a short nozzle may have a total height of 16 mm, a 2 mm ID at one end which is extended to a depth of ˜11.50 mm, then tapered to the tip diameter with a bore length of ˜2.5 mm. For the safe operation of tiny tip and uniform heating, the nozzles are made of C36000 Brass with thermal conductivity of ˜116 W/m-K.

### Tri-Extruder

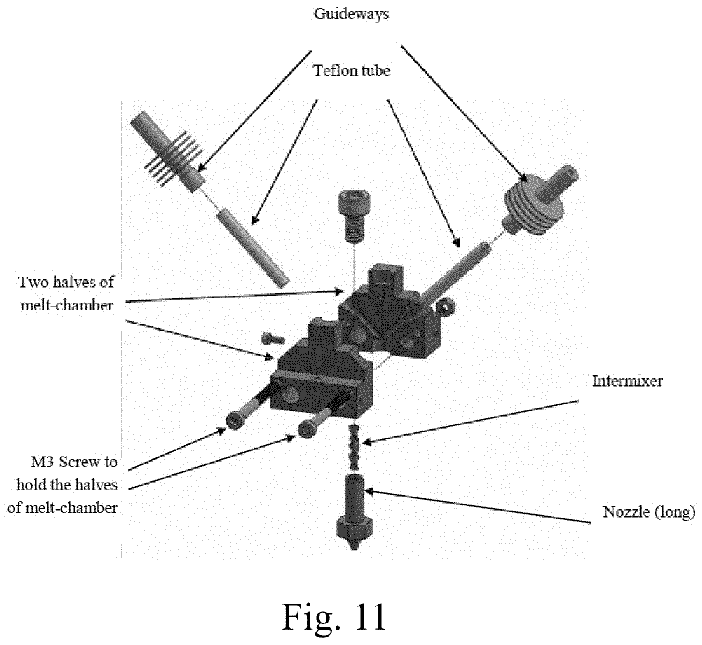

In other embodiments, a plurality of inlets, greater than two, may be provided, so long as they can be physically accommodated by the melt-chamber. In one embodiment, the multi-extruder of the present invention comprises a tri-extruder. The tri-extruder is configured similarly to the bi-extruder with guideways, a split melt-chamber, and nozzle, as depicted in the exploded view shown in FIG. 11. The tri-extruder adds a third central inlet, disposed between the two inclined guideways which are threaded into the melt-chamber.

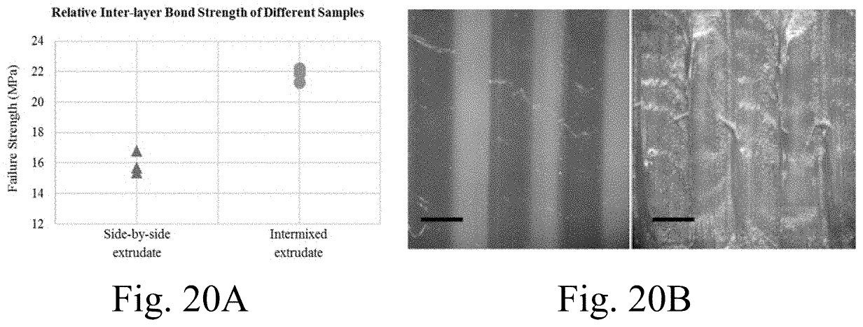

To reduce the mechanical friction between metal wall of the channel in the guideways and the filament, a Teflon™ tube with 4 mm OD and 2 mm ID was inserted into the 4 mm diameter guideways as shown in FIG. 20A. The Teflon™ tube was 5 mm longer than the guideways to cover the extra space into the melt-chamber before the guideway. It is to make sure that the internal diameter starting from the open end of the guideway to the mixing zone inside the melt-chamber is uniform and that is 2 mm. To help keep the Teflon™ tube in place the open end of the guideway is stepped to reduced diameter of 2 mm.

The central inlet may feed into the melt chamber such that all three materials are intermixed by the intermixer, or may feed into a central tube which runs through the centre of the intermixer, to be extruded in a central core extrudate surrounded by an intermixed, mechanically interlocked extrudate.

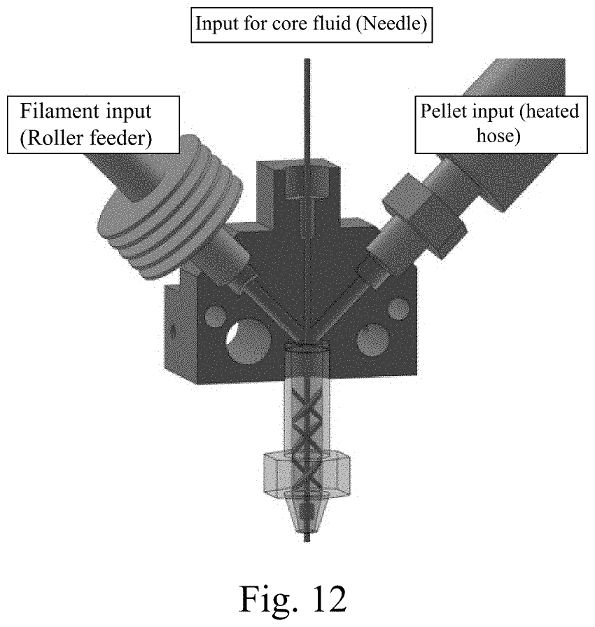

FIG. 12 shows a schematic of a tri-extruder having multiple different inputs. A first input comprises a guideway filament input as described above. A second input may comprise a melted material input, comprising a heated hose. The heated hose may comprise a heated, flexible hose such as that described in co-pending, co-owned U.S. Provisional Patent Application No. 62/729,259, filed Sep. 10, 2018, the entire contents of which are incorporated herein by reference. A central input may comprise a needle input for providing a core fluid, which could be liquid at room temperature or pre-melted before feeding to the third input. The core fluid extrudes as a core, while the filament and melted pellet input are intermixed and extrude around the core as a mechanically interlocked mixture. Thus, the resulting extrudate may comprise the co-axial extrusion of a metal and a polymer or mix of polymers. A similar device may also be fabricated by injecting liquid metal into a hollow, previously extruded tube.

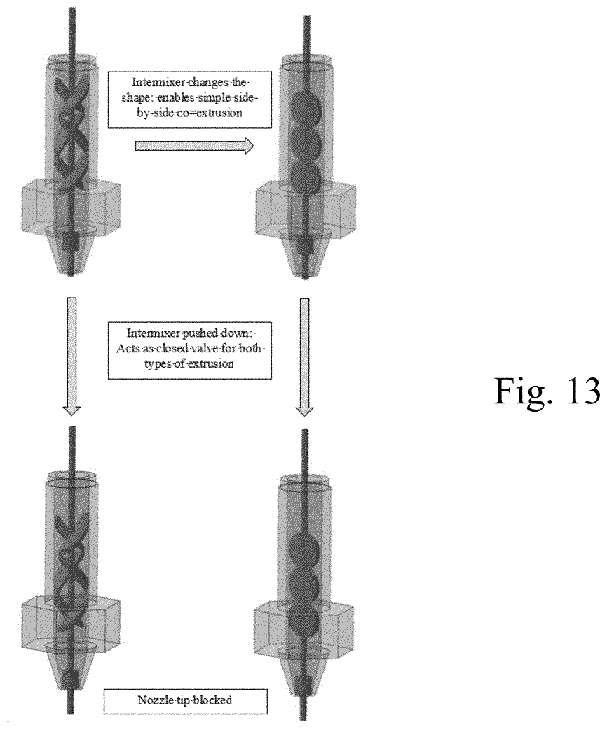

In one embodiment, a tri-extruder comprises a nozzle containing a convertible intermixer, a core needle and stop valve disposed on the core needle. The intermixer can be configured to force intermixing when the intermixing blades are deformed into the zig-zag shape or to permit side-by-side co-extrusion when straightened in the planar shape shown in FIG. 13, top right. In either case, the core needle can be translated vertically to position the stop valve in a closed position abutting the reduced diameter nozzle tip, closing off the extrusion opening, or in an open position, in a larger diameter section of the nozzle tip.

Embodiments of the present invention may provide 3D printed objects of blended extrudates of two immiscible polymers by using the novel multi-extruder (bi-extruder and tri-extruder) described herein. Four or more inputs are also possible. The multi-extruder has a split structure which permits easy access to the internal channels and its modular design with separate mixing chamber, inlet feed-guides, and nozzle, providing great flexibility for further modifications and optimization. With the insertion of an intermixer into the channel, side-by-side co-extrusion becomes intermixed co-extrusion resulting in a mechanically interlocked extrudate. Intermixed extrudates are found to have reduced delamination issues compared to side-by-side extrudates. Moreover, the bond strength of two adjacent filaments of intermixed polymers is higher than that of side-by-side polymers. Hence, objects printed with mechanical keying of two polymers have reduced delamination issues and improved mechanical bonding in transition from one material to another in printing FGM devices. The reduced internal lag-volume also improves the overall response time of the multi-extruder when changing the extrudate composition. The multi-extruder successfully prints such structures having enhanced performance. It can successfully extrude two polymers from a single nozzle with varying compositions and produce printed objects having improved intra and interlayer bonding. The composite sheets with mechanical keying showed higher breaking force compared to that of the side-by-side co-extruded sheets of the same materials.

Embodiments of the bi-extruder of the present disclosure is also capable of printing complex structures with inclined surfaces.

One embodiment of the bi-extruder was designed for 3 mm filament. Using 3 mm filament with nozzles smaller than 0.5 mm diameter increases pressure drop in the internal channel significantly, which may result in feeding issues like slip between the filament and the drive gear coupled with the motor. Smaller nozzles, such as commercially available 1.75 mm filaments may be used.

### EXAMPLES

Embodiments of the present invention may now be described with reference to the following Examples. These Examples are provided for the purpose of illustration only.

After installing the bi-extruder, several simple objects are printed to examine the extruder's performance. In this work, commercially available filaments of ABS, PLA, HIPS with 3-mm diameter are used. While printing using the bi-extruder, two filaments come in contact in the Y-shaped channel when they are already in molten state. Then, if no intermixer is present, both molten filaments advance and are extruded through the nozzle orifice in a side-by-side manner. Alternatively, if there is an intermixer inserted, both streams of molten polymer split, combine, re-split, and re-combine due to the orientation of intermixer's blade when passing through it. Therefore, due to this chaotic advection-type passive mixing, extrudates with mechanical keying of both materials is achieved.

### Example 1—Maximum Feed Speed

In overridden extrusion, the filaments are not fed to the melt-chamber causing slip in the motor-gear feeding assembly. Usually this leads to wear and tear of the filament at the location where the roller teeth touch the filament. Therefore, it is very important to know the maximum feed speed of an extruder for smooth extrusion without any kind of defects. In some embodiments, the maximum allowable combined feed speed of the filaments is 120 mm/min, which corresponds to feeding a 60-mm length of 3-mm diameter filament in one minute at each of the guide-ways. This feed rate is equivalent to a print speed of approximately 72 mm/s and 146 mm/s when using 0.5 mm and 0.35 mm nozzles respectively.

### Example 2—Response Test of the Bi-Extruder

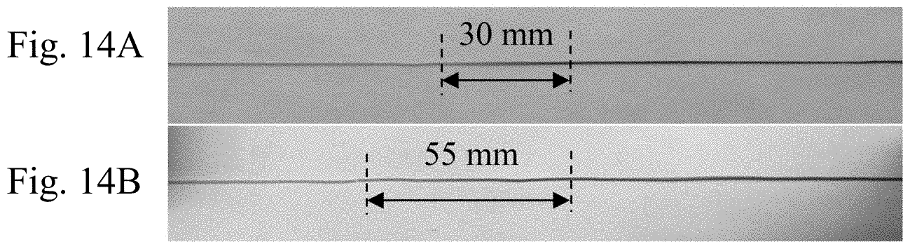

According to an embodiment, the Y-shaped internal channel has a volume of 10.8 mm³. When the extruder is instructed to change the composition of the extrudates, the material from this volume is extruded first, then the material with new composition can be realized. Therefore, this volume acts as a lag-volume. The smaller the lag-volume, the quicker the response of the extruder to a change in the feed composition. Inserting an intermixer not only results in interlocked extrudates, it also reduces the lag-volume, speeding the response of the extruder. FIG. 14A and FIG. 14B show that when using a 0.5 mm nozzle, the bi-extruder requires around 30 mm long extrudates to change the composition with an intermixer inserted. Without the intermixer, this length is nearly doubled (˜55 mm). For example, the bi-extruder is instructed to change the composition as a step input from 100% orange to 100% blue PLA.

### Example 3—Die Swell

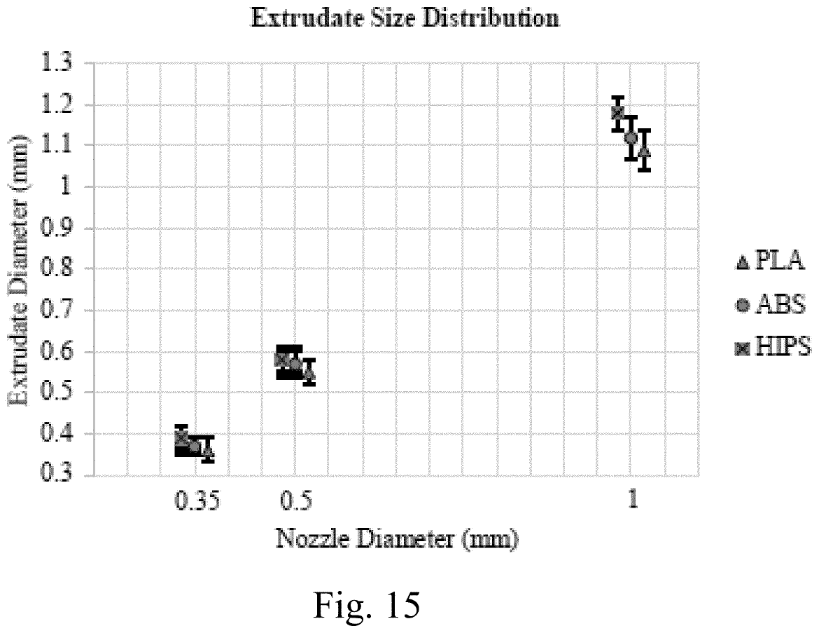

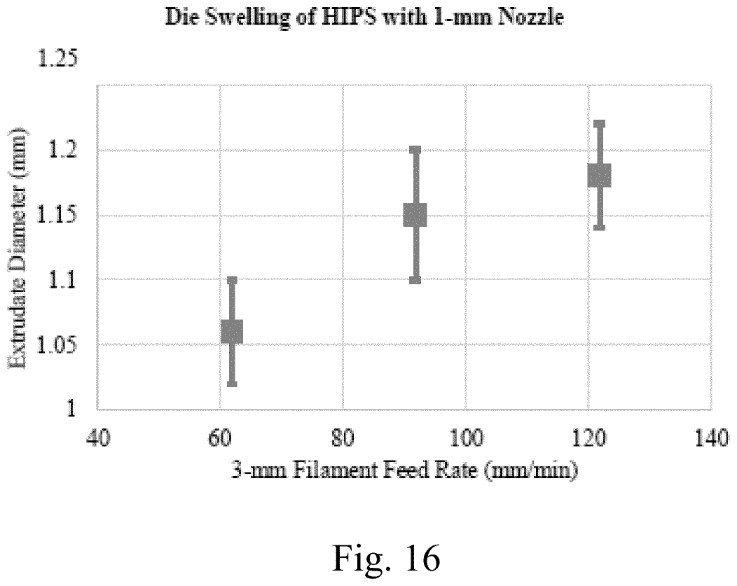

As mentioned above, die swell is a common phenomenon in polymer extrusion processes which should be considered while adjusting the layer width set by the slicing program used for 3D printing. While programming the trajectory of the print head to print an object by FDM technique, considering the effect of die swell will result in an optimal amount of overlap between adjacent deposited materials. To examine the die swell of ABS, PLA, and HIPS with the bi-extruder according to some forms of the present disclosure, the same filament is fed from both guide-ways and it is allowed to deposit a molten stream of polymer to get long extrudates of a single material. Then the diameter of each extrudate is measured at different locations and the statistics of the extrudate diameter vs. nozzle diameter are calculated as given in FIG. 15. It is found that regardless of nozzle diameter, HIPS extrudates show slightly higher swelling ratio compared to ABS and PLA. The effect of extrusion speed or feed speed on die swell has also been examined for different nozzle diameters. Die swell with 0.5 mm and 0.35 mm nozzles do not appear to be affected by feed speed to a statistically significant extent however with 1 mm nozzle the die swelling ratio is slightly higher at higher feed speed. This phenomenon is shown in FIG. 16 for HIPS.

### Example 4—Regulating Extrudate Composition

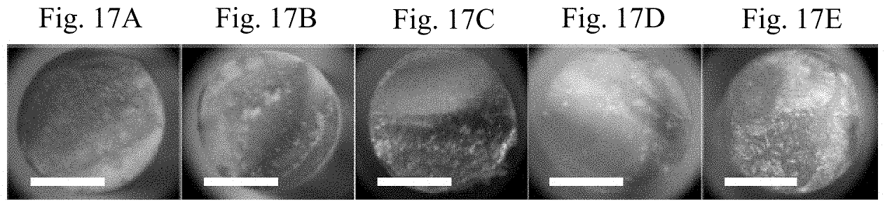

The composition of the extrudates is controlled by regulating the relative feed speeds of the filaments within the limit of maximum allowable feed speed (120 mm/min). For instance, to achieve a composition of 25% filament 1 and 75% filament 2, a feed speed of 30 mm/min is applied on filament 1 side while filament 2 is fed at 90 mm/min. If only one material is desired, then that particular filament would be fed at 120 mm/min speed and other filament will not be fed at all. FIGS. 17A to 17E shows microscope images of cross-sections of the extrudates with different compositions controlled by the relative feed speeds of the filaments while using a 0.5 mm nozzle. These extrudates are extruded without an intermixer inserted, so they are just side-by-side co-extrudates of red and green PLA. Instead of printing onto the bed, these extrudates are extruded in air approximately 15 cm above the print bed to allow cooling before reaching the print bed. Once the long extrudates are solidified, they are cut gently in the transverse direction such that the cross-section had little or no scratches from cutting. A 6-mm thick acrylic holder with through holes of different sizes cut by a CO₂ laser cutter is used to position the cross-sections of the extrudates facing up, to examine under a microscope. After post-processing of those images using National Instruments Vision Builder for Automated Inspection, the compositions are estimated as shown in FIGS. 17A to 17E.

### Example 5—Use of an Intermixer for Mechanical Interlocking

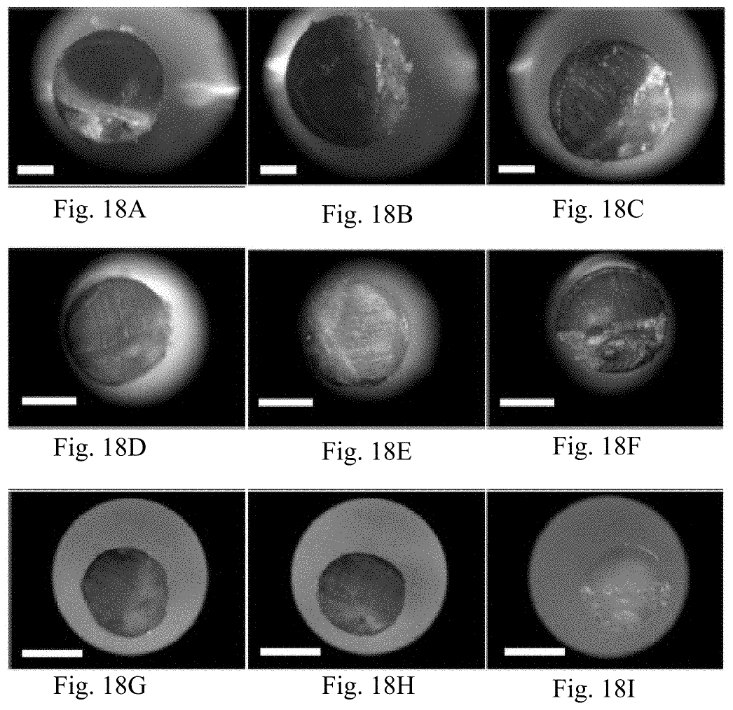

With the help of an intermixer inserted into the bi-extruder, mechanically interlocked extrudates of two dissimilar immiscible polymers is achieved. This circumvents the delamination problems common in multi-material FDM. FIGS. 18A to 18I shows some microscope images of cross-sections spaced approximately 5-mm along the length of a single extrudate. These images show that the mixing does not have any specific pattern, confirming the randomness of the mixing. The analysis is performed using all 1 mm, 0.5 mm, and 0.35 mm nozzles.

### Example 6—Nature of Failure in Tensile Test

A tensile test setup consists of a load cell (Transducer Techniques, MLP-10), a National Instrument Motion Controller (Model No. ESP301), a data acquisition (DAQ) hub (NI USB-6289) and two custom acrylic grippers using vials. The extrudate sample is wrapped around the smooth vial, and the acrylic gripper is used to securely hold the extrudate in position without affecting the extrudate surface. Then the load cell with the upper gripper is moved up slowly (50 μm/s) using a Windows Presentation Foundation (WPF) application written in C # by Samuel Lehmann, which is available as an open source solution. This tensile test is performed for both side-by-side co-extrudates and mechanically interlocked extrudates to observe the nature of failure. Microscope images of fractured cross-sections of the side-by-side co-extrudate with a diameter of 0.56±0.03 mm and mechanically interlocked extrudate with a diameter of 0.54±0.04 mm were examined. Both samples had a 50%-50% composition of green PLA and red HIPS. Due to the uneven cross-section of the fractured extrudates, the entire cross-section could not be focused. Similar qualitative experiments using extrudates of red HIPS and white ABS with 1:1 composition deposited using a 1-mm nozzle. To better demonstrate the delamination, thicker extrudates are used in this test. Delamination of the side-by-side co-extrudate is clearly demonstrated, whereas extrudate with mechanical keying shows full filament fracture.

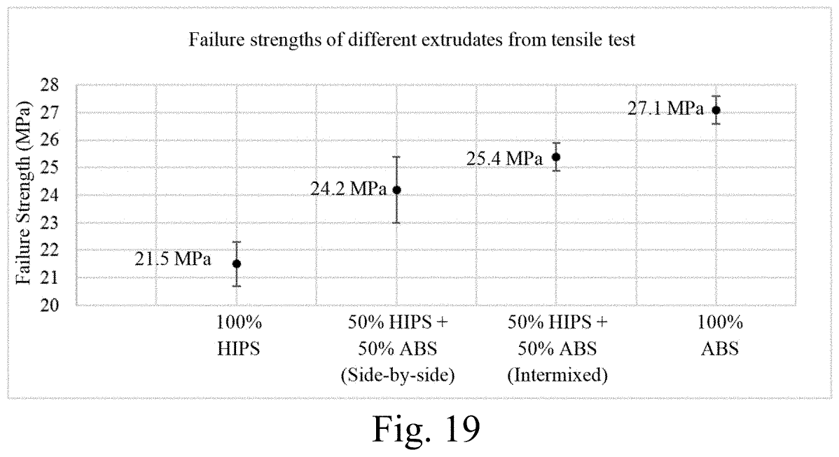

After appropriate calibration of the load cell, the failure strengths of four extrudate samples are measured as shown in FIG. 19. Each tensile test is repeated using five different samples. The failure strength of 1:1 HIPS-ABS extrudate lies between the failure strengths of pure HIPS and ABS extrudates. ABS extrudate exhibited the highest tensile strength of 27.1 MPa before failure, which is also in good agreement with literature. It is also found that the blended 1:1 HIPS-ABS extrudate failed at a tensile stress of 25.4±0.5 MPa, whereas side-by-side co-extrudate of the same material with same composition showed failure strength of 24.2±1.2 MPa. The overlap of the error values of intermixed and side-by-side extrudates indicates that the intermixing does not have any adverse effect on the extrudate tensile strength.

### Example 7—Relative Inter-Layer Bond Strength

The tensile test set-up used in Example 6 is used to estimate relative inter-layer bond strength of sheets printed by side-by-side and intermixed co-extrusion. The acrylic based gripper system is designed to firmly hold the samples without affecting their inter-layer bonding. The acrylic grippers have a patterned surface to increase friction between the sample and the gripper for better clamping. First, planar samples employing ASTM D1708 test standard are printed using a 1:1 composition of red ABS and green HIPS. The average thickness of the samples of only one layer thick is approximately 0.32 mm, when using 0.35 mm nozzle. While printing the samples, perimeter features are intentionally avoided and a linear fill pattern is chosen to reduce the effect of longitudinal border lines. The test aimed to compare the relative inter-layer bond strengths of beads printed by side-by-side and intermixed co-extrusion. Once the failure force is measured, using the cross-sectional area of the samples (˜0.32 mm×5 mm) it is converted to the bond strength in MPa. By this metric, the bond strength of three side-by-side co-extruded samples is measured as 15.7 MPa, 16.8 MPa and 15.4 MPa. The bond strengths of intermixed co-extruded samples are found to be 21.3 MPa, 21.9 MPa and 22.2 MPa. FIG. 20A shows the comparison between bond strengths of both types of samples. Microscope images (FIG. 20B) of both cross-sections of an intermixed sample and side-by-side samples at the point of failure during the tensile test were examined. Red ABS material interlocked within green HIPS material resisted delamination from material based phase separated region. In contrast, side-by-side co-extruded samples failed by complete delamination at lower tensile force at the interface of the two materials. The bimorph structure was clearly visible in side-by-side co-extruded surfaces, whereas there was no distinct edge of red Abs and green HIPS.

### Example 8—Objects Printed Using Bi-Extruder

Six cylinders made of either a single polymer or a pair of PLA, ABS, or HIPS with a 1:1 composition, were printed without an intermixer. During printing, as the print head moves from left to right on the print bed, the extruded material from the left filament stays on top of the material from the right filament and vice versa. Therefore, although the entire object has the same composition; the front side of the printed object seems to have one material dominant while the back side seems to have other material dominant. This phenomenon was easily observed in wheresome parts look mostly red while others look mostly green, due to the orientation of the printed object, however the entire object has the same 1:1 composition of both red and green materials.

Square box objects were printed with an intermixer inserted and with side-by-side co-extrudates. Although both boxes have the same 1:1 composition, the box printed with intermixed extrudate has a uniform color distribution on all four sides whereas the box printed with side-by-side extrusion has walls with one color more prominent on a certain side. One object was printed to show the transition from one material to another within a specified height.

### Example 9—Printing with Tri-Extruder Head

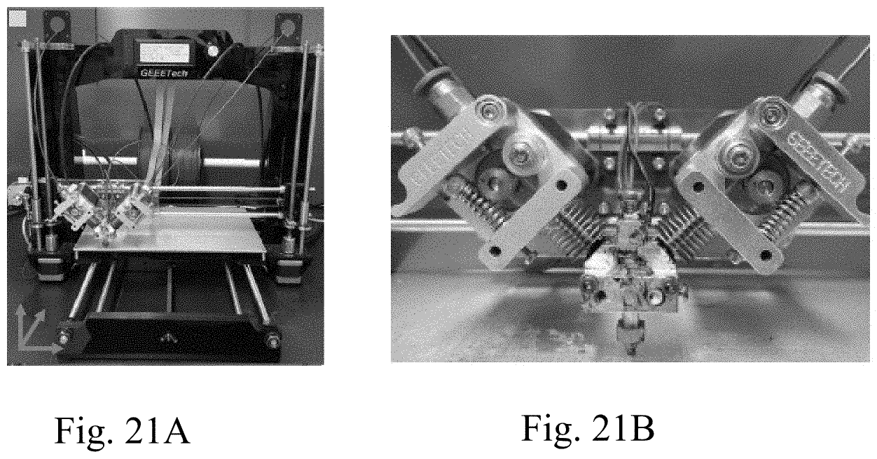

The original extruder for the printer is removed and the tri-extruder and feeder motors are connected with a custom bracket designed and cut from 6 mm thick acrylic sheet using CO₂ laser cutter. Thus, the assembled tri-extruder head is heavier than the original extruder which came with Bowden type feeder systems. FIG. 21A shows the complete 3D printer with a tri-extruder installed. The axes of the print defined in the firmware used are labeled. The left-right movement of the print head is done by the motor dedicated for X-axis, while front-back movement of the print bed is controlled by the Y-motor. Two Z-motors are used to achieve up-down movement of the extruder head. A detailed view of the assembled tri-extruder head is shown in FIG. 21B. This photo was taken when the long nozzle with intermixer was installed.

For side-by-side co-extrusion the exact position of the polymer phases is dependent on the print path orientation. For example, when printing from left to right, in the deposited filament, red HIPS stays on top blue ABS material and when printing from right to left, the filament has blue ABS on top of red HIPS material. While moving the head in front-back direction the materials from both left and right filaments stay side-by-side and do not change the relative position regardless of the movement of print head from front to back or back to front. Both types of 2D samples are referred to by the axis of infill lines.

For the user interface on the computer, an open source software, Repetier-Host was used. Then, another open source slicing software, Slicer was used to two-dimensionally slice the whole 3D STL model. Before the print starts, the composition of the polymers was set using the “Mixer” feature of the printer which allows different feed rates for the two input filaments to be set. To avoid warping and to ensure the first layer sticks to the print bed, an adhesive spray was applied.

### Example 10—Preparation of 1D: Extrudate Samples

The materials used during this work are commercially available acrylonitrile butadiene styrene (ABS), high impact polystyrene (HIPS) and polylactic acid (PLA). All the filaments have 1.75 mm diameter and are in different colors: red, blue, green and orange.

A FDM style 3D printer (model: M201) from Geeetech was used to print the parts. This printer is a 2-in-1-out version of a Prusa I3 series 3D printer, which feeds 2 filaments through one nozzle. It is also able to change the composition of the printing material by regulating the feed speed of the filaments while in printing. The printer does not have a closed environment chamber. However, it has a heated bed which can be heated up to 120° C. The printer comes with Bowden type feeder system for both the filaments. The original extruder head was replaced by the custom-built tri-extruder head, which uses a direct-mount feeder system.

Free extrusion from the nozzle is used to produce 1D extrudate samples. The continuity of intermixing of two different materials along the length of the extrudate is determined from these 1D samples. Both intermixed extrudate samples and side-by-side extrudate samples are produced and compared. To prepare these samples, the printer head was raised to a height of 20 cm above the print bed. Then, both left and right filaments were fed at the appropriate relative speed to achieve desired composition. The molten material was freely deposited onto the bed from the height of 20 cm. When the deposition extrudate reaches the bed, its temperature is already below glass transition temperature. So, the extrudate's circular cross-section is maintained even though it hits the bed. Long extrudate filaments were prepared with different composition of material combinations of PLA, ABS and HIPS at different extrusion temperatures.

### Example 11—Preparation of 2D: Planar Samples

The planar 2D samples with only one layer of thickness are used to test the average interlayer bond strength of two adjacent filaments. A rectangular sheet with only one layer thickness was printed with linear infill type in either X or Y alignment. Then the test specimens were cut from the rectangle by a CO₂ laser cutter. The samples are cut to align the filaments perpendicular to the loading direction. The ultimate strength of these samples represents the interlayer bond strength. Microscope images of the cross-sections where the samples failed were used to determine the mode of failure. Sections cut by a scalpel were used for image analyses of the original cross-section of the samples.

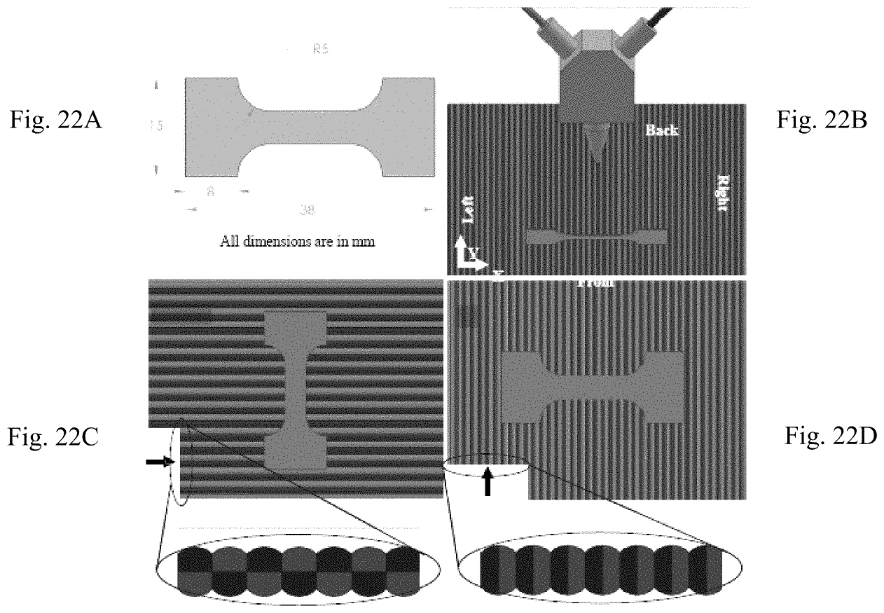

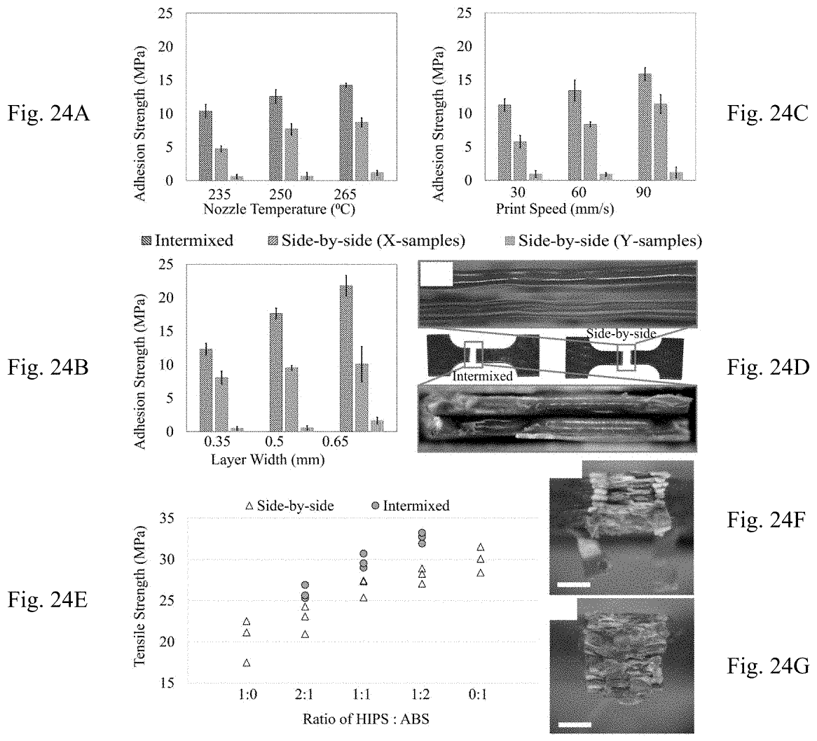

FIG. 22A shows the dimensions of a 2D planar sample as defined in ASTM D1708 standard. FIG. 22B shows the orientation of the print head and the directions of the print axes. In the case of side-by-side co-extrusion, X-samples and Y-samples have distinct appearance. X-samples are cut from the rectangle which was printed having infill lines aligned with the X-axis. Y-samples are from rectangles printed with infill lines aligned to the Y-axis. The position of an X-sample and the theoretical section view across the printed infills are shown in FIG. 22C whereas the detail of its counterpart Y-sample is given in FIG. 22D. The cross-sections of the adjacent beads from X-sample have two rows of alternating materials as shown in FIG. 24C. It is believed that, this structure of having the same material from adjacent beads closer at the center is favorable to polymer melt diffusion. On contrary, the cross-sections of Y-samples have true alternating arrangement (FIG. 22D) which does not permit same species diffusion. From the inset images in FIG. 22C and FIG. 22D, in Y-samples the width of the alternating colors is about the same as the nozzle orifice whereas that is about half of the nozzle opening in case of X-samples.

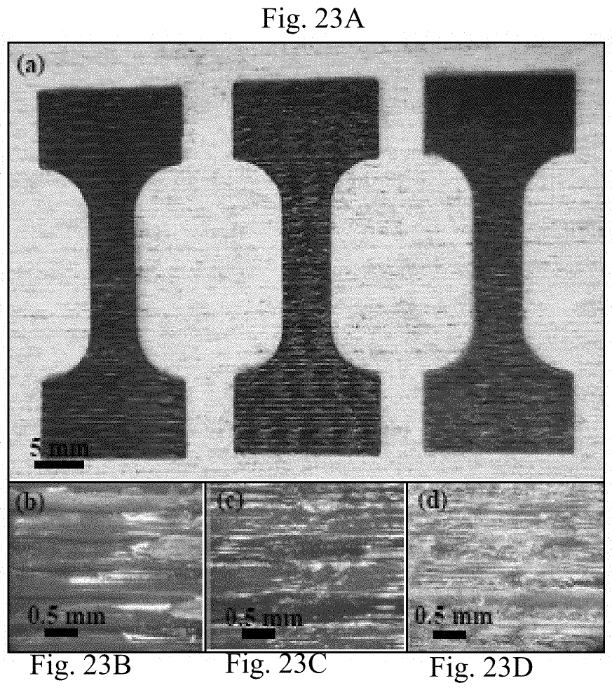

FIG. 23A to FIG. 23D shows different planar samples printed with the same 50%-50% composition of red HIPS and blue ABS. As expected, the Y-sample pitch of the alternating red and blue colors is approximately half that of the X-sample. The intermixed sample does not show as uniform or distinct red and blue structure and at some locations the same color from different beads fused together indicating mechanical keying across their cross-section.

### Example 12—Preparation of 3D: Object Samples

The ASTM D638-10 standard test method has five different test coupon dimensions, Type I through V. Due to the smaller print volume (120 mm×120 mm×100 mm) of the FDM system used here, Type I, II and III dimensions were not possible to print. The smallest test coupon Type V was also not utilized in this study due to its cross-sectional area which is within or close to a factor a ten compared to the print raster size. Hence, in this work, only Type IV test coupon has been used. The dimensions of a Type IV 3D sample are given in FIG. 23A. Photos of 3D samples of different composition of red HIPS and blue ABS printed with intermixed co-extrusion are depicted in FIG. 23B.

### Example 13—Tensile Test of 1D Extrudate Samples

Due to lack of FDM specific testing standard for extrudate evaluation, the 1D extrudate samples prepared here are tested using a custom set-up. For all the samples, a gage length of 25 mm was maintained between the vial grippers. The lower gripper is fixed while the upper gripper is moved vertically upward using a three-axes motion controller. The force probe was connected with the upper gripper and continuously monitored the force applied while testing. The force measured when the sample fails gives the ultimate strength of the extrudate sample. The extrudate samples of different material combinations such as PLA+ABS, ABS+HIPS and HIPS+PLA, with 1:1 ratio were tested; however, it was found that the ABS+HIPS samples have highest likelihood of delamination compared to other samples. Hence, in this study, results of only ABS+HIPS samples have been presented.

### Example 14—Effect of Nozzle Temperature

The extrudate samples of ABS+HIPS are prepared with different nozzle temperature, 230° C., 240° C. and 250° C. In FIG. 24A, some graphs with error bar show how the extrudate size and mechanical strength changes with extrusion temperature. In this experiment, only 0.5 mm nozzle was used to produce the extrudates and all the tests were repeated thrice. Both side-by-side and intermixed extrudates were found to have smaller diameter as the nozzle temperature increases. This can be attributed to the decreased viscosity of the polymer melt at higher temperature at a specific extrusion speed i.e. shear rate. Due to lower viscosity or higher fluidity the extrudates at 250° C. temperatures result in average diameter even smaller than nozzle orifice, as the extrudates were produced in a hanging position right after it extrudes from nozzle tip. At 230° C. and 240° C., die swelling is observed which is common in extrusion processes. Although the extrudate diameter changes with nozzle temperature, the ultimate mechanical strengths of the extrudates from different extrusion temperatures are statistically indistinguishable. Not only that, the intermixing has found to have no significant effect on the ultimate strength of the extrudates confirming the continuity and consistency of the intermixing.

### Example 15—Effect of Print Speed

The apparent shear rate is maximum at the nozzle tip compared to other locations inside the flow channels. This shear rate again depends on the extrusion speed applied. In case of 0.5 mm nozzle, the extrusion speed examined are 50 mm/s, 70 mm/s and 90 mm/s of the extrudate. The maximum apparent shear-rate (γₐₚₚ) corresponding to the respective print speeds are 800 s⁻⁵, 1120 s⁻¹ and 1440 s⁻¹. It is observed that, at 90 mm/s print speed, the feeder motor-roller assembly had consistency issue and got stuck randomly. This is because of the limit imposed by the maximum allowable heat flux transferrable to the material for this extruder design. With other print speeds, both side-by-side and intermixed co-extrudate were prepared and tested. Theoretically higher shear rate would cause lower viscosity of the viscoelastic polymer melt, thus resulting in similar effect of extrusion temperature. However, no noticeable effect of print speed on extrudate strength was observed.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

### REFERENCES

The following references are indicative of the level of skill of one skilled in the art, and are incorporated herein in their entirety for all purposes.
Agarwala, M. K., Jamalabad, V. R., Langrana, N. A., Safari, A., Whalen, P. J. and Danforth, S. C. (1996), “Structural quality of parts processed by fused deposition”, Rapid Prototyping Journal, Vol. 2, No. 4, pp. 4-19.
Ahn, D. K., Kim, H. C. and Lee, S. H. (2005), “Determination of fabrication direction to minimize post-machining in FDM by prediction of non-linear roughness characteristics”, Journal of Mechanical Science and Technology, Vol. 19, No. 1, pp. 144-155.
Altinkaynak, A., Gupta, M., Spalding, M. A. and Crabtree, S. L. (2011), “Melting in a single screw extruder: Experiments and 3D finite element simulations”, International Polymer Processing, Vol. 26, No. 2, pp. 182-196.
Bartolo, P. J. (2011), Stereolithography: Materials, Processes and Applications, Springer US.
Bellini, A., Guceri, S. and Bertoldi, M. (2004), “Liquefier dynamics in fused deposition”, Journal of Manufacturing Science and Engineering, Vol. 126, No. 2, pp. 237-246.
Bruyas, A., Geiskopf, F. and Renaud, P. (2014), “Towards Statically Balanced Complaint Joints Using Multimaterial 3D Printing”, “Towards Statically Balanced Complaint Joints Using Multimaterial 3D Printing”, ASME, Aug. 17-20, 2014.
Brydson, J. A. (1981), Flow properties of polymer melts, Van Nostrand Reinhold Co., London, UK.
Bschaden, B. S. (2014), Developing design guidelines for improved gecko inspired dry adhesive, University of Alberta.
Cengel, Y. A. (2007), Heat & Mass Transfer: A Practical Approach, McGraw-Hill, India.
Chen, J., Shi, Y., Yang, J., Zhang, N., Huang, T. and Wang, Y. (2013), “Improving interfacial adhesion between immiscible polymers by carbon nanotubes”, Polymer, Vol. 54, No. 1, pp. 464-471.
Chua, C. K., Leong, K. F. and Lim, C. S. (2010), Rapid Prototyping: Principles and Applications, World Scientific.
Cole, P. J., Cook, R. F. and Macosko, C. W. (2003), “Adhesion between immiscible polymers correlated with interfacial entanglements”, Macromolecules, Vol. 36, No. 8, pp. 2808-2815.
Coogan T J and David O K 2017 Bond and part strength in fused deposition modeling Rapid Prototyping Journal 23 414-22
Cverna, F. (2002), ASM Ready Reference: Thermal properties of metals, illustrated ed., ASM International, Materials Park, Ohio.
Dawson, P. C. (1999), “Flow Properties of Molten Polymers”, in G. M. Swallowe (Ed.), Mechanical Properties and Testing of Polymers, 1st edition ed., Springer Netherlands, pp. 88-95.
Dong, W., He, M., Wang, H., Ren, F., Zhang, J., Zhao, X. and Li, Y. (2015a), “PLLA/ABS blends compatibilized by reactive comb polymers: Double tg depression and significantly improved toughness”, ACS Sustainable Chemistry & Engineering, Vol. 3, No. 10, pp. 2542-2550.
Dong, W., Wang, H., He, M., Ren, F., Zheng, Q. and Li, Y. (2015b), “Synthesis of reactive comb polymers and their applications as a highly efficient compatibilizer in immiscible polymer blends”, Industrial & Engineering Chemistry Research, Vol. 54, No. 7, pp. 2081-2089.
Elkins, K., Nordby, H., Janak, C., Gray, R. W., Bohn, J. H. and Baird, D. G. (1997), “Soft elastomers for fused deposition modeling”, “Soft elastomers for fused deposition modeling”, Laboratory for Freeform Fabrication and University of Texas at Austin, pp. 441.
Espalin, D., Medina, F., Arcaute, K., Zinniel, B., Hoppe, T. and Wicker, R. (2009), “Effects of Vapor Smoothing on ABS Part Dimensions”, “Effects of Vapor Smoothing on ABS Part Dimensions”, University of Texas, Schaumburg, pp. pp 1-17.
Faes, M., Ferraris, E. and Moens, D. (2016), “Influence of inter-layer cooling time on the quasi-static properties of ABS components produced via fused deposition modelling”, 18th CIRP Conference on Electro Physical and Chemical Machining (ISEM XVIII), Vol. 42, pp. 748-753.
Flory, P. J. (1942), “Thermodynamics of high polymer solutions”, The Journal of Chemical Physics, Vol. 10, No. 1, pp. 51-61.
Gibson, I., Rosen, D. W. and Stucker, B. (2010), Additive Manufacturing Technologies: Rapid Prototyping to Direct Digital Manufacturing, Springer US, New York, N.Y.
Hashmi, S. (2014), Comprehensive Materials Processing, Elsevier Science.
Hessel, V., Löwe, H. and Schönfeld, F. (2005), “Micromixers—a review on passive and active mixing principles”, Chemical Engineering Science, Vol. 60, No. 8-9, pp. 2479-2501.
Jin, X., Heepe, L., Strueben, J., Adelung, R., Gorb, S. N. and Staubitz, A. (2014), “Challenges and solutions for joining polymer materials”, Macromolecular Rapid Communications, Vol. 35, No. 18, pp. 1551-1570.
Jo, W. H., Yang, J. S., Creton, C., Kramer, E. J., Brown, H. R., Hui, C. and Suematsu, K. (2002), “Molecular Simulation Fracture Gel Theory”, Advances in Polymer Science Springer-Berlin Heidelberg, pp. 228.
Kaysser, W. A. and Ilschner, B. (1995), “FGM research activities in europe”, MRS Bulletin, Vol. 20, No. 1, pp. 22-26.
Khondoker, M. A. H. and Sameoto, D. (2016), “Design and Characterization of a Bi-Material Co-Extruder for Fused Deposition Modeling”, “Design and Characterization of a Bi-Material Co-Extruder for Fused Deposition Modeling”, The American Society of Mechanical Engineers, November 11-17, pp. IMECE2016-65330.
Kim, Y. F., Choi, C. N., Kim, Y. D., Lee, K. Y. and Lee, M. S. (2004), “Compatibilization of immiscible poly(l-lactide) and low density polyethylene blends”, Fibers and Polymers, Vol. 5, No. 4, pp. 270-274.
Koizumi, M. and Niino, M. (1995), “Overview of FGM research in japan”, MRS Bulletin, Vol. 20, No. 1, pp. 19-21.
Koning, C., Van Duin, M., Pagnoulle, C. and Jerome, R. (1998), “Strategies for compatibilization of polymer blends”, Progress in Polymer Science, Vol. 23, No. 4, pp. 707-757.
Lee, C., Wang, W., Liu, C. and Fu, L. (2016), “Passive mixers in microfluidic systems: A review”, Chemical Engineering Journal, Vol. 288, pp. 146-160.
Lipson, H. and Kurman, M. (2013), Fabricated: The New World of 3D Printing, John Wiley & Sons.
M. Zandvakili, M. M. Honari, D. Sameoto and P. Mousavi (2016), “Microfluidic liquid metal based mechanically reconfigurable antenna using reversible gecko adhesive based bonding”, “Microfluidic liquid metal based mechanically reconfigurable antenna using reversible gecko adhesive based bonding”, 2016 IEEE MTT-S International Microwave Symposium (IMS), pp. 1.
McKelvey, J. M. (1962), Polymer processing, John Wiley and Sons, Inc., New York, USA.
Michaeli, W. (2003), Extrusion Dies for Plastics and Rubber, Carl Hanser Verlag GmbH & Co. KG.
Osswald, T. A. and Hernandez-Ortiz, J. P. (2006), Polymer Processing: Modeling and Simulation, Hanser Publishers, Munich.
Pandey, P. M., Venkata Reddy, N. and Dhande, S. G. (2003), “Improvement of surface finish by staircase machining in fused deposition modeling”, Journal of Materials Processing Technology, Vol. 132, No. 1-3, pp. 323-331.
Park, J. (1998), Characterization of the Laminated Object Manufacturing (LOM) Process and Applications, University of California, Los Angeles.
Rabin, B. H. and Shiota, I. (1995), “Functionally gradient materials”, MRS Bulletin, Vol. 20, No. 1, pp. 14-18.
Ramanath, H. S., Chua, C. K., Leong, K. F. and Shah, K. D. (2008), “Melt flow behaviour of poly-\hat{ι}μ-caprolactone in fused deposition modelling”, Journal of Materials Science: Materials in Medicine, Vol. 19, No. 7, pp. 2541-2550.
Rodriguez, J. F., Thomas, J. P. and Renaud, J. E. (2001), “Mechanical behavior of acrylonitrile butadiene styrene (ABS) fused deposition materials. experimental investigation”, Rapid Prototyping Journal, Vol. 7, No. 3, pp. 148-158.
Stoyanov, H., Kollosche, M., Risse, S., Wache, R. and Kofod, G. (2013), “Soft conductive elastomer materials for stretchable electronics and voltage controlled artificial muscles”, Advanced Materials, Vol. 25, No. 4, pp. 578-583.
Subcommittee F42.91 on Terminology (2012), “Standard terminology for additive manufacturing technologies”, ASTM International, pp. Designation: F2792-12a.
Sung-Hoon Ahn, Montero, M., Odell, D., Roundy, S. and Wright, P. K. (2002), “Anisotropic material properties of fused deposition modeling ABS”, Rapid Prototyping Journal, Vol. 8, No. 4, pp. 248-257.
Surhone, L. M., Timpledon, M. T. and Marseken, S. F. (2010), Selective Laser Sintering, VDM Publishing.
Tan, Z. Y., Xu, X. F., Sun, S. L., Zhou, C., Ao, Y. H., Zhang, H. X. and Han, Y. (2006), “Influence of rubber content in ABS in wide range on the mechanical properties and morphology of PC/ABS blends with different composition”, Polymer Engineering & Science, Vol. 46, No. 10, pp. 1476-1484.
Taufik, M. and Jain, P. K. (2016), “A study of build edge profile for prediction of surface roughness in fused deposition modeling”, Journal of Manufacturing Science and Engineering, Vol. 138, No. 6, pp. 061002.
Turner, B. N. and Scott, A. G. (2015), “A review of melt extrusion additive manufacturing processes: II. materials, dimensional accuracy, and surface roughness”, Rapid Prototyping Journal, Vol. 21, No. 3, pp. 250-261.
Turner, B. N., Strong, R. and Gold, S. A. (2014), “A review of melt extrusion additive manufacturing processes: I. process design and modeling”, Rapid Prototyping Journal, Vol. 20, No. 3, pp. 192-204.
Vadori, R. (2012), Studies on the Blending of Poly(Lactic Acid) and Acrylonitrile Butadiene Styrene, University of Guelph.
Wang, T., Xi, J. and Jin, Y. (2007), “A model research for prototype warp deformation in the FDM process”, The International Journal of Advanced Manufacturing Technology, Vol. 33, No. 11, pp. 1087-1096.
Yadroitsev, I. (2009), Selective Laser Melting: Direct Manufacturing of 3D-objects by Selective Laser Melting of Metal Powders, Lambert Academic Publishing.
Yan H, Chen Y, Deng Y, Zhang L, Hong X, Lau W, Mei J, Hui D, Yan H and Liu Y 2016 Coaxial printing method for directly writing stretchable cable as strain sensor Appl. Phys. Lett. 109 083502
Zeng, J., Li, K. and Du, A. (2015), “Compatibilization strategies in poly(lactic acid)-based blends”, RSC Advances, Vol. 5, No. 41, pp. 32546-32565.
Srivatsan T S and Sudarshan T S 2015 Additive Manufacturing: Innovations, Advances, and Applications, ed Anonymous CRC Press)
Stucker B. Additive Manufacturing Technologies: Technology Introduction and Business Implications. Frontiers of Engineering: Reports on Leading-Edge Engineering from the 2011 Symposium Washington, D.C.: The National Academies Press; 2012. p. 5-162
Caulfield B, McHugh P E and Lohfeld S. 2007 J Mater Process Technol 182 477-88
Zhou C, Chen Y, Yang Z and Khoshnevis B 2011 (Austin, Tex., USA) Anonymous Laboratory for Freeform Fabrication and University of Texas at Austin) p 65
M. A. Jafari, Han W, Mohammadi F, Safari A, S. C. Danforth and Langrana N 2000 Rapid Prototyping J. 6 161-75
Pilleux M E, Safari A, Allahverdi M, Chen Y, Lu Y and Jafari M A 2002 Rapid Prototyping J. 8 46-52
Geeetech Prusa 13 M201 3D printer. 2014; Available at: http://www.geeetech.com/geeetech-prusa-i3-m201-3d-printer-diy-kit-p-965.html. Accessed Apr. 15, 2016 and also Available at: http://www.geeetech.com/wiki/index.php/Geeetech_Prusa_I3_M201. Accessed Dec. 2, 2016
Big Builder 3D Printer Dual—Feed. 2016; Available at: http://builder3dprinters.com/products/big-builder-dual-feed-overview/. Accessed Apr. 15, 2016
Diamond Hotend makes multi-color 3D printing possible from a single nozzle. 2015; Available at: http://www.gizmag.com/diamondhotend-color-3d-printer-extruder/36950/. Accessed Apr. 15, 2016
Flory P J 1942 J. Chem. Phys. 10 51-61
Brochard F, Jouffroy J and Levinson P 1983 Macromolecules 16 1638-41
Koning C, Van Duin M, Pagnoulle C and Jerome R 1998 Prog. Polym. Sci. 23 707-57
Dong W, He M, Wang H, Ren F, Zhang J, Zhao X and Li Y 2015 ACS Sustainable Chem. Eng. 3 2542-50
Dong W, Wang H, He M, Ren F, Zheng Q and Li Y 2015 Ind. Eng. Chem. Res. 54 2081-9
Chen J, Shi Y, Yang J, Zhang N, Huang T and Wang Y 2013 Polymer 54 464-71
Jin X, Heepe L, Strueben J, Adelung R, Gorb S N and Staubitz A 2014 Macromolecular Rapid Communications 35 1551-70
Cverna F 2002 ASM Ready Reference: Thermal Properties of Metals, ed Anonymous (Materials Park, Ohio: ASM International) p 560
Hessel V, Löwe H and Schönfeld F 2005 Chemical Engineering Science 60 2479-501
Lee C, Wang W, Liu C and Fu L 2016 Chem. Eng. J. 288 146-60
England H C and Voigt W C. 1976 US Patent
Torrado A R and Roberson D A 2016 Journal of Failure Analysis and Prevention 16 154-64
Khondoker M A H and Sameoto D 2017 Rapid Prototyping J. 24
Wang J and Porter R S 1995 Rheologica Acta 34 496-503
Dawson P C. Flow Properties of Molten Polymers. In: Swallowe G M, editor. Mechanical Properties and Testing of Polymers. 1st edition ed.: Springer Netherlands; 1999. p. 88-95
Kumar N G 1980 Journal of Polymer Science: Macromolecular Reviews 15 255-325

1. An additive manufacturing extruder comprising:
(a) a melt chamber comprising a heat source, and having a first inlet for receiving a first extrudable material and a second inlet for receiving a second extrudable material, and an interior channel leading to an outlet leading to a nozzle; and
(b) an intermixer associated with the outlet or the nozzle, the intermixer configured to direct flow of one or both of the two extrudable materials to produce a mechanically keyed extrudate.

2. The extruder of claim 1 further comprising at least two guideways, each attached to a respective inlet, and each adapted to receive filament materials.

3. The extruder of claim 2 wherein each guideway comprises a cooling or heat dissipation element.

4. The extruder of claim 3 wherein each guideway heat dissipation element comprises a plurality of heat dissipating fins or disks.

5. The extruder of claim 1 wherein the melt chamber includes two separable pieces joined together by at least one fastener.

6. The extruder of claim 5 wherein the two separable halves are identical or symmetrical.

7. The extruder of claim 1 wherein the intermixer is static or passive.

8. The extruder of claim 7 wherein the intermixer comprises at least one inclined or helical blade.

9. The extruder of claim 7 wherein the intermixer defines a hollow core around which at least one inclined or helical blade is arranged.

10. The extruder of claim 8 wherein the intermixer comprises a plurality of semi-elliptical blades, which are moveable between an in-line side-by-side arrangement and a zig-zag intermixing arrangement.

11. The extruder of claim 1 wherein the interior channel is Y-shaped.

12. The extruder of any of claim 1 further comprising a third inlet channel formed in said melt chamber and fluidly connected with the interior channel or which connects to a tube passing through the interior channel.

13. The extruder of claim 13 wherein the third inlet connects to an axially central tube upon which the intermixer is mounted.

14. The extruder of claim 2 wherein said first and second guideways are each lined with a friction-reducing tube.

15. The extruder of claim 1 wherein said first and second guideways are each positioned at a 45° angle relative to a longitudinal axis of the lower section of the interior channel of said melt chamber.

16. The extruder of claim 1 further comprising a valve axially moveable between a closed position blocking the nozzle and an open position allowing material flow through the nozzle.

17. The extruder of claim 17 wherein the valve may be positioned in an intermediate position, creating a reduced diameter passage in the nozzle.

18. The extruder of claim 17 wherein the valve is mounted on an axially central tube upon which the intermixer is mounted.

19. A method of extruding two dissimilar materials to produce a mechanically keyed extrudate, the method comprising the steps of:
(a) advancing a first material and second material into a melt chamber;
(b) melting the first and second materials;
(c) Extruding the first and second materials through an intermixer and out a nozzle.

20. The method of claim 19 wherein the first and second materials are each filamentous polymers.

21. The method of claim 19 comprising the further step of advancing a third material into the melt chamber to be intermixed with the first and/or second materials, or to in side-by-side co-extrusion with the mechanically keyed first and second materials.

22. The method of claim 21 wherein the third material forms a core of the extrudate resulting from a coaxial extrusion of the first, second and third materials.

23. The method of claim 22 wherein the third material comprises a polymer or a metal.
